(19) United States
(12) Patent Application Publication
(10) Pub. No.: US 2011/0248690 A1
(43) Pub. Date: Oct. 13, 2011

(54) POWER SUPPLY CIRCUIT FOR COMBUSTION APPLIANCE

(75) Inventor: Frank Mimick, Watauga, TX (US)

(73) Assignee: MAXITROL COMPANY, Southfield, MI (US)

(21) Appl. No.: 13/082,020

(22) Filed: Apr. 7, 2011

Related U.S. Application Data
(60) Provisional application No. 61/321,733, filed on Apr. 7, 2010.

(51) Int. Cl. G05F 1/563; H02M 7/04

(52) U.S. Cl. 323/266; 363/125

(57) ABSTRACT

An electrical circuit includes a rectifier having an input for receiving an alternating current (AC) voltage and an output for supplying a first direct current (DC) voltage. The circuit also includes a first regulator having an input electrically connected to the rectifier for receiving the first DC voltage and an output for supplying a second DC voltage. The circuit further includes a second regulator having an input electrically connected to the output of the first regulator for receiving the second DC voltage and an output for providing a third DC voltage.

### CROSS REFERENCE TO RELATED APPLICATION

This application claims the benefit of provisional patent application No. 61/321,733, filed Apr. 7, 2010, which is hereby incorporated by reference.

### BACKGROUND

1. Field of the Invention

The subject matter generally relates to a circuit that receives AC power at an input and provides DC power at an output. The subject matter specifically relates to a circuit that provides DC power to a controller for regulating a combustion appliance.

2. Description of the Related Art

The operation of combustion appliances, e.g., gas stoves, fireplaces, etc., is improved with greater control over the temperature produced by such appliances. Temperature sensors, regulating devices, and associated control circuits are typically utilized to provide such control. However, these electrical devices and circuits are quite sensitive to fluctuation in voltage as well as under- and over-voltage conditions. As such, there is a need for a power supply circuit that provides a uniform and well-regulated voltage to these devices.

### BRIEF SUMMARY

The subject application discloses an electrical circuit. The circuit includes a rectifier having an input for receiving an alternating current (AC) voltage and an output for supplying a first direct current (DC) voltage. The circuit also includes a first regulator having an input electrically connected to the rectifier for receiving the first DC voltage and an output for supplying a second DC voltage. The circuit further includes a second regulator having an input electrically connected to the output of the first regulator for receiving the second DC voltage and an output for providing a third DC voltage.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a block diagram of a power supply circuit providing electrical power to a controller; and

FIG. 2 is an electrical schematic diagram of a portion of the power supply circuit.

### DETAILED DESCRIPTION

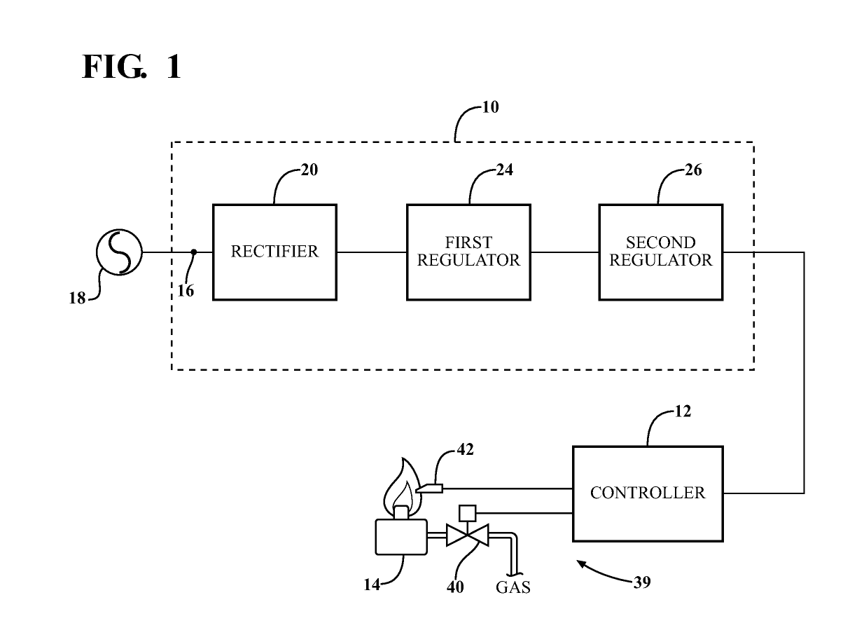

Referring to the Figures, a power supply circuit 10 is shown herein. In the illustrated embodiment, with reference to FIG. 1, the circuit 10 provides a uniform output voltage to a controller 12 of a combustion appliance 14, such as a gas burner (not separately numbered). Specifically, in the illustrated embodiment, the controller 12 controls the temperature produced by the combustion appliance 14, as described in greater detail below. However, those skilled in the art will realize other applications for the circuit 10 described herein.

The circuit 10 includes an input port 16 for receiving an alternating current (AC) input voltage. In the illustrated embodiment, the AC input voltage is provided by a nominal voltage source 18 electrically connected to the input port 16. Specifically, in the illustrated embodiment, the nominal voltage source 18 provides 24 VAC. The nominal voltage source 18 may be implemented as a transformer (not shown) for converting the standard 120 VAC power typically found in North America. Of course, those skilled in the art realize that other voltages may be transformed as well as other techniques to implement the nominal voltage source 18. Furthermore, in other embodiments, the nominal voltage source 18 may provide the input port 16 an AC voltage different from 24 VAC.

In fact, one problem with the nominal voltage source 14 is that the actual voltage could be actually higher than the desired voltage. For instance, in the illustrated embodiment, where the desired voltage from the nominal voltage source 14 is 24 VAC, the actual voltage produced may be as high as 32 VAC. Due to the potential for this abnormally high input voltage, often the electronic circuits downstream do not operate reliably.

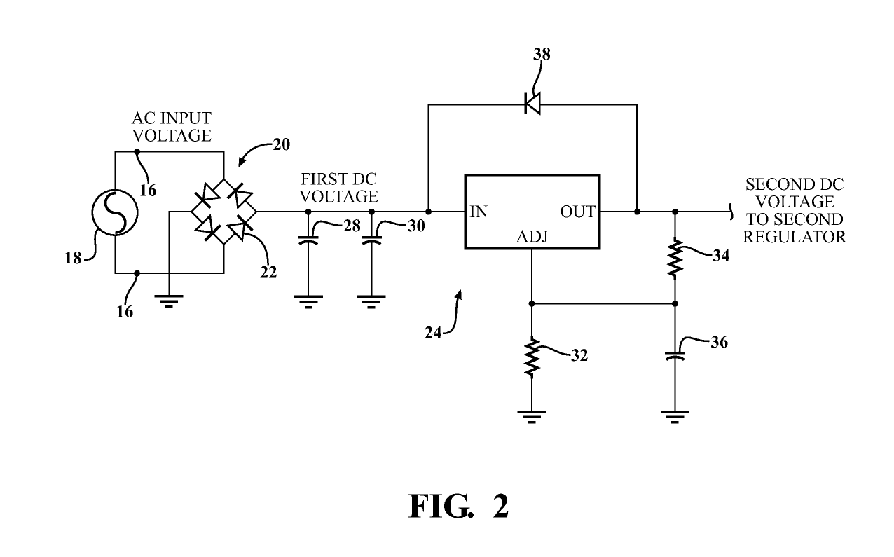

The circuit 10 includes a rectifier 20 electrically connected to the input port 16. The rectifier 20 includes an input (not numbered) for receiving the AC voltage and an output (not numbered) for supplying a first direct current (DC) voltage. The first DC voltage may is unconditioned and may alternatively be referred to as an unconditioned DC voltage. In the illustrated embodiment, and as shown in FIG. 2, the rectifier 20 is a full-wave bridge type utilizing four diodes 22 as is well known to those skilled in the art. Of course, other techniques and components may be alternatively be utilized to implement the rectifier 20.

The circuit 10 further includes a first regulator 24 having an input (not numbered) electrically connected to the rectifier 20 for receiving the first DC voltage. The first regulator 24 also includes an output for supplying a second DC voltage. In the illustrated embodiment, the first regulator 24 is implemented as an adjustable voltage regulator. Specifically, in the illustrated embodiment, the first regulator 24 is implemented with an LM317 3-terminal adjustable regulator. Numerous manufacturers supply implementations of the LM317 regulator, including, but not limited to, National Semiconductor Corporation headquartered in Santa Clara, Calif. As the LM317 has three terminals, the first regulator 24 of the illustrated embodiment includes the input, the output, and an adjustment terminal (not numbered). The adjustment terminal allows for adjusting the differential between the input and output of the first regulator 24. That is, the adjustment terminal allows for adjusting the differential between the first DC voltage and the second DC voltage. Of course, in other embodiments, the first regulator 24 may be implemented with a different suitable component. For instance, the first regulator 24 may be implemented with an adjustable voltage regulator other than the LM317.

The circuit 10 also includes a second regulator 26 having an input (not numbered) and an output (not numbered). The input of the second regulator 26 is electrically connected to the output of the first regulator 24 for receiving the second DC voltage from the first regulator 24. The output of the second regulator provides a third DC voltage. In the illustrated embodiment, the second regulator 26 is implemented with a 3-terminal positive voltage regulator. Specifically, in the illustrated embodiment, the second regulator 26 is implemented with an LM7824 3-terminal positive voltage regulator. Numerous manufacturers supply implementations of the LM7824 regulator, including, but not limited to, Fairchild Semiconductor Corporation, headquartered in San Joe, Calif. Of course, in other embodiments, the second regulator 26 may be implemented with a different suitable component.

The second DC voltage provided by the first regulator 24 is higher than the first DC voltage received by the first regulator 24. Accordingly, the second DC voltage is also higher than the AC input voltage received by the rectifier 20. Specifically, in the illustrated embodiment, the second DC voltage is about 1.4 times the AC input voltage. Therefore, when the AC input voltage is 24 VAC, the second DC voltage is about 34 VDC.

Furthermore, the second DC voltage provided by the first regulator 24 is always higher than the third DC voltage provided by the second regulator 26. That is, the first regulator 24 provides a voltage higher than that required by the controller 14.

As the second DC voltage being always higher than the third DC voltage, the first regulator 24 acts as a pre-regulator to the second regulator 26 with overvoltage protection. The second DC voltage being higher than the first and third DC voltages is achieved with the component selection and interconnection as described below.

Specifically, in the illustrated embodiment, as shown in FIG. 2, the circuit 10 includes a first capacitor 28 and a second capacitor 30 electrically each electrically connected between the input of the first regulator 24 and ground. Of course, as the first regulator 24 and the rectifier 20 are electrically connected, the first and second capacitors 28, 30 are also electrically connected between the output of the rectifier 20 and ground.

The first capacitor 28 preferably has a capacitance less than 2000 μF. More preferably, the first capacitor 28 has a capacitance less than 1000 μF. Specifically, in the illustrated embodiment, the first capacitor 28 has a capacitance of about 800 μF. Moreover, in the illustrated embodiment, the first capacitor 28 has a voltage rating of about 50 V.

The second capacitor 30 preferably has a capacitance less than 0.1 μF. More preferably, the capacitance of the second capacitor 30 is less than 0.05 μF. Specifically, in the illustrated embodiment, the second capacitor 30 comprises a ceramic material and has a capacitance of about 0.01 μF.

The circuit 10 of the illustrated embodiment also includes a first resistor 32 electrically connected between the adjustment terminal of the first regulator 24 and ground. The circuit 10 of the illustrated embodiment also includes a second resistor 34 electrically connected between the adjustment terminal and the output of the first regulator 24. Preferably, the first resistor 32 has a greater resistance than the second resistor 34. More preferably, a ratio of resistance of the first resistor 32 to the second resistor 34 is at least 20:1. Even more preferably, the ratio of resistance of the first resistor 32 to the second resistor 34 is at least 25:1. Specifically, in the illustrated embodiment, the resistance of the first resistor is about 6.8 kΩ and the resistance of the second resistor is about 240Ω. The ratio between the first resistor 32 to the second resistor 34 is important in producing the second DC voltage as higher than the first DC voltage.

The circuit 10 of the illustrated embodiment further includes a third capacitor 36 electrically connected between the adjustment terminal of the first regulator 24 and ground. Said another way, the third capacitor 36 is electrically connected in parallel with the first resistor 32. The third capacitor 36 preferably has a capacitance less than 0.1 μF. More preferably, the capacitance of the third capacitor 36 is less than 0.05 μF. Specifically, in the illustrated embodiment, the third capacitor 36 comprises a ceramic material and has a capacitance of about 0.01 μF.

The circuit 10 further includes a diode 38 electrically connected between the input and output of the first regulator 24 to provide protection to the first regulator 24. Of course, the values and configurations of the electronic components described above and otherwise herein may be varied based on design considerations, such as different desired input and output voltages.

The components of the circuit 10 may be supported by a printed circuit board (not shown). The printed circuit board, as is well known to those skilled in the art, provides electrical connections between the components.

As alluded to above, and with reference again to FIG. 1, the circuit 10 is particularly suited for providing power to the controller 16. In the illustrated embodiment, the controller 16 is electrically connected to the second regulator 26 and regulates the temperature produced by the combustion appliance 14. The controller 16 may be a microprocessor-based device or other appropriate circuitry well known to those skilled in the art. The combustion appliance 14 may be a gas fired appliance, including, but not limited to, an air heater or a boiler. In one alternative embodiment, the combustion appliance 14 may be a solid fuel (e.g., wood) burning stove. Those skilled in the art will realize other suitable devices that may be controlled by the controller 12 powered by the circuit 10.

A control system 39 of the illustrated embodiment includes the controller 16 as well as a combustion element regulator 40 and a temperature sensor 42. The combustion element regulator 40 in the illustrated embodiment is implemented as a control valve (not separately numbered) for regulating an amount of gas supplied to the combustion appliance 40.

The temperature sensor 42 is in communication with the controller 16 and senses a temperature related to the combustion appliance 14. The temperature sensor 42 may be an RTD, thermocouple, or other suitable device as realized by those skilled in the art. In the illustrated embodiment, the temperature sensor 42 senses the temperature of air emanating from the combustion appliance 14. The controller 16 utilizes the temperature reading provided by the temperature sensor 42 to control operation of the regulator 40.

Accordingly, the combustion element regulator 40 is also in communication with the controller 12. Specifically, the controller 12 produces a signal that controls the operation of the combustion element regulator 40. In the illustrated embodiment, the control signal changes the amount of gas supplied to the combustion appliance 14 in order to maintain a certain temperature produced by the combustion appliance 14. In other embodiments, for example, the amount of air provided to the combustion appliance 14 may be controlled.

The third DC voltage provided to the controller 16 is also utilized by the temperature sensor 42 and the regulator 40. Due to the sensitive nature of the temperature sensor 42 and the regulator 40, there is a need for the third DC voltage to be uniform. In instances where the voltage is not uniform, incorrect readings from the temperature sensor 42 may be obtained and improper control of the regulator 40 may occur.

As such, the third DC voltage provided by the circuit 10 is generally uniform and well-regulated. Said another way, the circuit 10 provides a uniform regulated DC output voltage that does not significantly vary based on fluctuations and signal noise associated with the AC input voltage.

The circuit 10 is also able to absorb normal and transient over-voltage conditions. During normal operations from high input voltage operations, the circuit 10 is able to reduce the first DC voltage to the uniform third DC voltage to be used by the electronic circuits of the controller 12. During transient conditions, where the first DC voltage may become excessive, the circuit 10 is able to absorb a higher power level during those transient conditions.

The circuit 10 is further able to reduce both the voltage ripple as well as the input noise level. Due to the voltage regulation operation, voltage ripple is almost zero at normal levels. This voltage regulating operation is also able to remove or reduce any noise from the AC input voltage source 18.

Moreover, the circuit 10 is able to provide over-load protection to the devices powered by it, e.g., the controller 12. Under fault conditions caused by the controller 12 or other connection problems, the circuit 10 is able to limit output power to a level that is non-catastrophic. This may allow the controller 12 to be returned to normal operations when the fault condition is removed.

The present invention has been described herein in an illustrative manner, and it is to be understood that the terminology which has been used is intended to be in the nature of words of description rather than of limitation. Obviously, many modifications and variations of the invention are possible in light of the above teachings.

What is claimed is:

1. An electrical circuit comprising:
a rectifier having an input for receiving an alternating current (AC) voltage and an output for supplying a first direct current (DC) voltage;
a first regulator having an input electrically connected to said rectifier for receiving the first DC voltage and an output for supplying a second DC voltage; and
a second regulator having an input electrically connected to said output of said first regulator for receiving the second DC voltage and an output for providing a third DC voltage.

2. An electrical circuit as set forth in claim 1 wherein the second DC voltage provided by said first regulator is higher than the third DC voltage provided by said second regulator.

3. An electrical circuit as set forth in claim 1 wherein the second DC voltage provided by said first regulator is higher than the first DC voltage received by said first regulator.

4. An electrical circuit as set forth in claim 1 further comprising a first capacitor and a second capacitor each electrically connected between said input of said first regulator and ground.

5. An electrical circuit as set forth in claim 4 wherein said first capacitor has a capacitance less than 2000 μF and said second capacitor has a capacitance less than 0.1 μF.

6. An electrical circuit as set forth in claim 5 wherein said first capacitor has a capacitance less than 1000 μF.

7. An electrical circuit as set forth in claim 6 wherein said first capacitor has a capacitance of about 800 μF.

8. An electrical circuit as set forth in claim 5 wherein said second capacitor has a capacitance less than 0.05 μF.

9. An electrical circuit as set forth in claim 8 wherein said second capacitor has a capacitance of about 0.01 μF.

10. An electrical circuit as set forth in claim 4 wherein said first regulator further includes an adjustment terminal for adjusting the differential between the first DC voltage and the second DC voltage.

11. An electrical circuit as set forth in claim 10 further comprising a first resistor electrically connected between said adjustment terminal of said first regulator and ground, a second resistor electrically connected between said adjustment terminal and said output of said first regulator, and a third capacitor electrically connected between said adjustment terminal and ground.

12. An electrical circuit as set forth in claim 11 wherein said first resistor has a greater resistance than said second resistor.

13. An electrical circuit as set forth in claim 11 wherein a ratio of resistance of said first resistor to said second resistor is at least 20:1.

14. An electrical circuit as set forth in claim 11 wherein a ratio of resistance of said first resistor to said second resistor is at least 25:1.

15. An electrical circuit as set forth in claim 14 wherein the resistance of said first resistor is about 6.8 kΩ and the resistance of said second resistor is about 240Ω.

16. An electrical circuit as set forth in claim 11 wherein said third capacitor has a capacitance less than 0.1 μF.

17. An electrical circuit as set forth in claim 16 wherein said third capacitor has a capacitance of about 0.01 μF.

18. An electrical circuit as set forth in claim 11 wherein said first regulator is an LM317 regulator.

19. A control system for controlling a combustion appliance,
said system comprising
a rectifier having an input for receiving an alternating current (AC) voltage and an output for supplying a first direct current (DC) voltage;
a first regulator having an input electrically connected to said rectifier for receiving the first DC voltage and an output for supplying a second DC voltage;
a second regulator having an input electrically connected to said output of said first regulator for receiving the second DC voltage and an output for providing a third DC voltage wherein the second DC voltage provided by said first regulator is higher than the first DC voltage provided by the rectifier and higher than the third DC voltage provided by said second regulator;
a temperature sensor for sensing a temperature related to the combustion appliance;
a combustion element regulator for regulating combustion of a fuel by the combustion appliance; and
a controller electrically connected to said second regulator for receiving the third DC voltage and in communication with said temperature sensor and said combustion element regulator for controlling the combustion element regulator to maintain a certain temperature.

20. A system as set forth in claim 18 wherein the second DC voltage provided by said first regulator is higher than the third DC voltage provided by said second regulator.
